(19) United States
(12) Patent Application Publication
(10) Pub. No.: US 2012/0052376 A1
(43) Pub. Date: Mar. 1, 2012

(54) ZINC POWDER AND FIBER MIXTURES FOR ELECTROCHEMICAL BATTERIES AND CELLS

(75) Inventors: Xiaoge Gregory Zhang, Toronto (CA); Audrey Marylin Boutin, Milton (CA)

(73) Assignee: TECK METALS LTD., Vancouver (CA)

(21) Appl. No.: 13/035,975

(22) Filed: Feb. 27, 2011

Related U.S. Application Data
(60) Provisional application No. 61/309,770, filed on Mar. 2, 2010.

(51) Int. Cl. H01M 4/42; H01M 4/02; H01M 10/26

(52) U.S. Cl. 429/206; 429/229; 429/226; 141/1.1; 252/182.1

(57) ABSTRACT

Electrochemical cells having a cathode, a zinc anode including a mixture of zinc fibers and zinc powder, and electrolyte are provided. The zinc fiber and zinc powder may have selected physical and compositional attributes. Methods of preparing such electrochemical cells are also provided. Such electrochemical cells may provide improved discharging performance under power-demanding conditions.

### REFERENCE TO RELATED APPLICATION

This application claims the benefit under 35 U.S.C. §119 of U.S. Patent Application No. 61/309770 filed on 2 Mar. 2010 and entitled ZINC POWDER AND FIBER MIXTURES FOR ELECTROCHEMICAL BATTERIES AND CELLS which is hereby incorporated herein by reference.

### TECHNICAL FIELD

This invention relates to mixtures of zinc powder and fibers for electrochemical devices, including batteries, electrochemical cells and electrochemical energy storage materials, which include zinc fibers, zinc powders and anode gels.

### BACKGROUND

Manufacturers of energy supplying devices such as zinc batteries and fuel cells are constantly seeking ways to improve the performance of electrochemical energy supplying devices due to the continued emergence of new power-demanding electronic devices requiring mobile power sources. There is an ever-increasing demand for batteries that will provide higher power without sacrificing other desirable battery performance characteristics, such as long discharge life (high capacity), long storage life, resistance to electrolyte leakage, and ease of manufacture.

Particulate zinc materials can be characterized by parameters such as specific surface area, effective surface area, surface activity, porosity, electrical conductivity, and mechanical stability. An anode made of selected zinc powder can result in good performance in a battery with a known design because of the combined effect of such parameters.

Atomized zinc powder is the current commercial form of material used in alkaline Zn—MnO₂ and primary zinc-air cells. Atomized zinc powder has a large specific surface area, on the order of about 0.02 m²/g, thereby allowing anodes made with such zinc powder to be capable of delivering high levels of electrical current. The atomized zinc powder used in alkaline battery applications, before being mixed with electrolyte, has a typical density of 3 to 3.5 g/cm³, which provides a zinc volume of about 42% to 50%, and porosities in the 50% to 58% range. To achieve the required typical porosity of about 70% for electrochemical cell applications, manufacturers use a gelling agent for the mixture of zinc powder and electrolyte so that the zinc particles are not densely packed, but suspended in an electrolyte gel. With too little porosity, the anode may not have good reactivity. With excessive porosity, the anode may have poor conductivity.

Various methods have been adopted to improve the performance of anodes made of atomized zinc powders. For example, blending powders with different particle distributions can result in significantly improved discharging performance, as disclosed in U.S. Pat. No. 6,284,410, issued Sep. 4, 2001, and granted to Duracell Inc.

Applying the principles used for blending powders with different particle distributions, the addition of different forms of material, such as ribbons, flakes and needles, etc., has also been described in the prior art. Such materials have one or two dimensions that are larger than that of atomized powder to improve the particle to particle connectivity and the conductivity of the electrode. It is conceivable that larger dimensions would provide even better connectivity and conductivity. However, there is a limit to such increases in dimension. Above a certain limit, the fluidity of the powder gel mixture can become poor, thereby interfering with battery fabrication processes.

Mixing different forms of material to improve the connectivity of gelled zinc powder anodes, and thus the discharging performance of alkaline batteries using such materials, has been proposed in the prior art. For example, U.S. Pat. No. 6,221,527, issued Apr. 24, 2001, granted to Eveready Battery Company, describes the use of zinc “ribbons” to improve the high rate discharge capacity of alkaline cells. U.S. Pat. No. 6,022,639, issued Feb. 8, 2000, and U.S. Pat. No. 7,045,253, issued May 16, 2006, both granted to Eveready Battery Company, teach the addition of zinc flakes to anode gels.

The use of fibers in alkaline battery applications has also been proposed. U.S. Pat. No. 3,853,625, issued Dec. 10, 1974 to Union Carbide Corporation, describes a method for producing zinc needles and fibers through electrolysis of a soluble zinc salt-containing electrolyte solution and the manufacture of a solid anode by compression molding of zinc fibers and needles. However, the actual performance of such material in terms of discharging rate and gassing rate, etc., was not demonstrated in actual alkaline cells. In U.S. Patent Application No. 2003/0170543 A1, published Sep. 11, 2003, assigned to Altrista Zinc Products Company L.P., zinc fibers manufactured by mechanical milling are described for potential application in alkaline batteries. However, fibers produced by such a method have a shortcoming related to hydrogen gassing caused by surface contamination from the metal cutting tool and coolant during the fiber fabrication process.

PCT Patent Application No. WO 2004/012886 A2, published Feb. 12, 2004, applicant Noranda Inc., describes the use of zinc powder particles that are teardrop, needle-like, or spherical in shape for improving anode performance. Compared to straight fibers, such materials have smaller volumetric aspect ratios. Furthermore, such particles, in the shape of needles with round heads on one end, can hinder gel fluidity in battery production processes.

U.S. Pat. No. 7,291,186, issued Nov. 6, 2007 to Teck Cominco Metals Ltd., discloses an invention using zinc fibers for making solid porous zinc electrodes. However, the patent does not teach the use of zinc fiber and powder mixtures to make non-solid electrodes. Furthermore, the zinc fibers used in making solid porous electrodes must be sufficiently long to provide sufficient fiber entanglement for mechanical integrity. The fibers used in gel anodes are limited in length. Long fibers can negatively affect the fluidity of the gel and the battery manufacturing process.

### SUMMARY OF THE INVENTION

This invention has various aspects. One aspect of the invention provides zinc fiber and zinc powder mixtures for use in gelled anodes. It has been found that such mixtures can significantly improve the discharging performance of electrochemical cells such as alkaline batteries and zinc-air batteries. The mixtures disclosed herein may be used in conventional battery manufacturing operations.

Another aspect of the invention provides electrochemical cells and batteries which comprise gel electrodes comprising mixtures of zinc fibers and zinc powders. Such electrochemical cells and batteries may provide improved discharging performance under power-demanding conditions. In specific embodiments, the zinc fiber and zinc powder material has selected physical and compositional attributes. In certain embodiments, the proportion of zinc fibers that is mixed with the zinc powder gel electrode materials is within specified ranges for desirable performance. Experimental data indicate that the addition of zinc fibers to the zinc powder in the gel can increase discharging capacity by more than 20% under some power demanding conditions, for example when 10% of the total zinc content is in the form of fibers.

Further aspects of the invention and features of specific example embodiments are described below.

### BRIEF DESCRIPTION OF THE DRAWINGS

Exemplary embodiments are illustrated in referenced figures of the drawings. The embodiments and figures disclosed herein are illustrative and not restrictive.

FIG. 1 is an illustration of an elongated rounded particle of certain length and thickness.

FIGS. 2A through 2H are schematic illustrations showing various forms of particulate materials.

FIG. 3A is a photograph of a particulate material having particles in the form of fibers. FIG. 3B is a photograph of a particulate material having fibers in the form of flakes.

FIG. 4 is a schematic cross section of an example electrochemical cell with a negative electrode containing fibrous zinc.

FIG. 5 is a bar graph depiction of average performance index at 0.8 V cut-off for “all powder” cells (i.e. 0% fiber) and 10% fiber (% of total zinc content only, not including electrolyte and additives) under various discharge regimes.

FIG. 6 is a bar graph depiction of gassing test results for various alloy compositions (in ppm) (medium fiber thickness and medium fiber length).

FIG. 7 is a cross section view of a nozzle that may be used to test the flow and loading capability of a fibrous gel slurry.

### DETAILED DESCRIPTION OF SPECIFIC EMBODIMENTS OF THE INVENTION

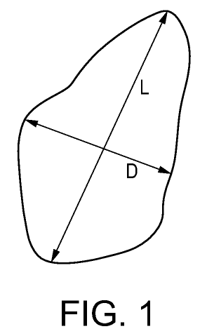

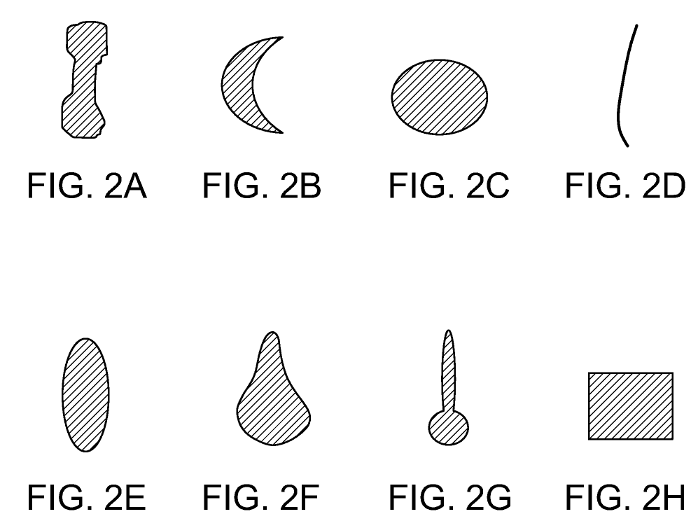

Aspect ratio is often used for describing and comparing the forms of particulate materials. Because aspect ratio only reflects shape in two dimensions, it is a useful parameter for describing similar forms of materials, but it is not useful for comparisons to be made between different forms of materials, such as between flakes and fibers. To compare different forms of materials, the measurement should preferably be reflected in three dimensions. One can use volumetric aspect ratio (VAR) to describe and measure the forms of various particulate materials. Volumetric aspect ratio is defined as the longest dimension of a particle divided by the largest circumference along the length dimension. For example, the volumetric aspect ratio for a sphere is 1/π, while for a cylinder, with a length of 10 times that of the diameter, the ratio is 10/π. For an irregular but more or less round particle, which is applicable to most particles of atomized zinc powder as illustrated in FIG. 1, the volumetric aspect ratio can be expressed as L/Dπ. Volumetric aspect ratio not only measures the relative difference between the longest dimension and shortest dimension of a particle, but also measures the effective length in a given volume of material or degree of elongation of particles. It is conceivable that the larger the VAR, the better the connectivity for such material. For various forms as illustrated in FIGS. 2A through 2H, the fiber form has the largest volumetric aspect ratio.

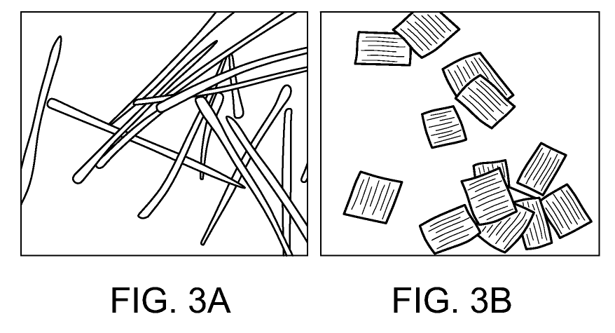

To illustrate one particular property of fibers which can have a significant effect on the connectivity and conductivity of the collective body of particulate material, a comparative test was carried out to measure the VAR of a fiber sample in comparison to a flake sample. FIGS. 3A and 3B are respectively photographs of zinc fiber material and zinc flake material. The VAR for each material was determined by measuring the length, width, and thickness or diameter of 100 individual flakes and fibers. The average results of these measurements are shown in Table 1.

TABLE 1
Measurement of Volumetric Aspect Ratio (VAR) of different forms of
particulate materials (average value of 100 particles)

| | Fiber | Flake | Sphere |
|---|---|---|---|
| Length (mm) | 4.54 | 1.46 | |
| Width (mm) | | 1.07 | |
| Thickness (mm) | | 0.04 | |
| Diameter (mm) | 0.14 | | Any |
| VAR | 10.3 | 0.66 | 0.32 |

It can be seen from the results in Table 1 that the VAR of the fiber form of particulate material is much larger than the VAR of the flake form, which is two times the VAR of the spherical form. Thus, the volumetric aspect ratio is a quantity that can be used to effectively describe the form of particulate material.

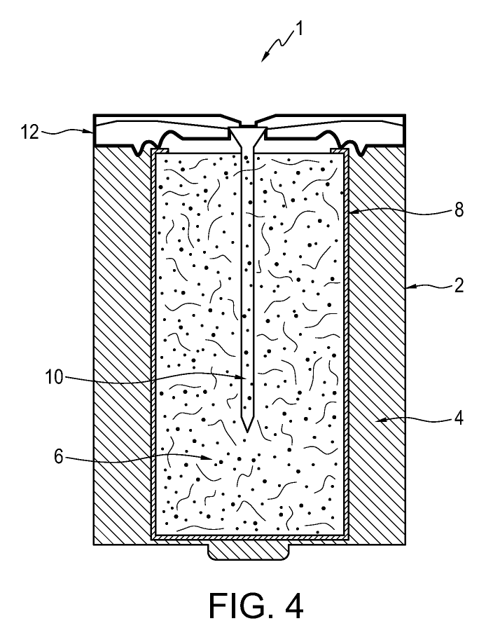

FIG. 4 is a depiction of the basic structure of an alkaline cell 1 that includes zinc fibers. Cell 1 has a cylindrical cell housing 2 that also serves as a positive electrode current collector. A positive electrode 4 is located adjacent to the inner sidewalls of cell housing 2. The positive electrode 4 is in the shape of a hollow cylinder which may be impact molded inside housing 2 or inserted as a plurality of rings after molding, for example. A negative electrode 6 (a gel comprising or consisting of zinc powder, zinc fibers, electrolyte and additives), is placed within the hollow cavity of positive electrode 4. The hollow cavity of the positive electrode 4 is lined with a separator 8. Cell 1 is enclosed by a collector assembly 10 and an outer terminal cover 12.

The zinc fibers in negative electrode 6 may be made from zinc alloys that include selected metals to control hydrogen gassing and improve the activity of the zinc fiber. The alloy metals may include, for example, one or more of Bi, In, Al, Sn, Pb, Mg, and Ca with quantities varying from 10 ppm to 5000 ppm.

This invention in one aspect is directed at zinc fiber and zinc powder mixtures for anode gels for use in alkaline or zinc-air batteries to improve high rate discharge performance. The amount of fiber used can range from 5% to 35% on a zinc material basis, preferably between 8% and 20%. The length of the fibers may vary between 2 mm to 10 mm, preferably 3 mm to 6 mm; and, the diameter or the thickness of the fibers may vary between 0.05 mm and 0.3 mm, preferably 0.1 mm to 0.2 mm. The cross section of the fibers may vary from nearly circular to nearly semi-circular shape. Other shapes may be possible. The fiber mixture may contain fibers of different shapes and dimensions, including fibers of different lengths. The fiber mixture may contain varying proportions of fibers with different lengths, thicknesses and shapes. In all variations, the zinc fiber mixture is mixed with zinc powder in a gel material to make an electrode.

The discharge performance of the fiber and powder anode gel mixtures, the gassing rate of fibers, and the fluidity of the gel are important factors. Experiments have been carried out to demonstrate performance improvements, verify low gassing rates of zinc alloy fibers, and to determine preferred ranges for physical dimensions and proportions of fibers and powders usable in battery manufacturing.

### EXAMPLE 1

In this example, experiments were conducted to compare the discharging performance of fiber/powder mixtures to zinc powders only. Zinc fibers were 10% by weight of the zinc fiber/powder mixture (not including other additives). Table 2 shows the composition of the anode gel mixture.

TABLE 2
List of ingredients for anode gel mixtures

| Wt % | Additive |
|---|---|
| 67.0 | Zinc Powders & Fibers |
| 31.7 | Electrolyte (35% KOH with 2% ZnO) |
| 0.86 | 4% In₂(SO₄)₃ solution |
| 0.48 | Gelling Agent (Carbopol ™ 940) |

Partially completed AA cell consoles with the cathode and separator already in place were used for making test cells. Consoles were supplied by Pure Energy Battery Corporation. A known amount of anode gel (containing Carbopol 940™, manufactured by The Lubrizol Corporation, and distributed by L.V. Lomas) was loaded into the cavity of the consoles and the open end was sealed with a cap. The assembled cells were then discharged at various load profiles as specified in Table 3.Ten to twelve cells were tested for each discharge regime.

TABLE 3
Description of various discharge regimes

| | |
|---|---|
| 4-step cyclic | Cycles of: 510 mA for 2.5 min, 850 mA for 2.5 min, |
| | 1.88 A for 30s, Rest for 1 min Until 0.5 V cut-off |
| | (Note: “Rest” means no discharge current or not under |
| | discharge.) |
| Pulse | Cycles of: 1.8 A for 5 s, Rest for 10 s Until 0.5 V cut-off |
| 1 A | Continuous 1 A |
| Continuous | Until 0.5 V cut-off |
| DSC-ANSI | Cycles of A & B: |
| (Digital Still | A) 10 cycles of: 1.5 W for 2 s, 0.65 W for 28 s |
| Camera: ANSI | B) Rest for 55 min |
| standard) | Until 0.5 V cut-off |

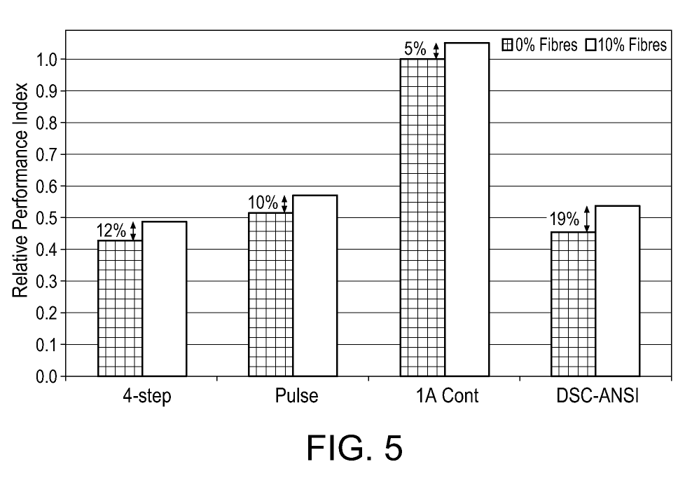

FIG. 5 shows the resulting average performance index for cells containing either only powders (0% fibers); or, containing 10% fibers and 90% powders, of the total zinc content (not including electrolyte and additives). It should be noted that the “Relative Performance Index” (RPI) in FIG. 5 is an indicator of cell performance relative to the baseline of 0% fibers discharged at 1 A continuously (where RPI=1.0). It appears that the percentage improvement with fiber addition in comparison to no fiber addition increases with the discharging power. As much as 19% improvement was achieved for the DSC-ANSI discharging profile. Under the “1 A continuous” discharge regime, where 1 A current was drawn from the cell continuously, only 5% relative improvement was observed. However, under more power-demanding discharging profiles (“Pulse” or “4-step cyclic”) 10% and 12% relative improvement was observed respectively. These results clearly indicate that the addition of zinc fibers provides improvement to the discharging performance of gel anodes in alkaline cells at high drain conditions.

### EXAMPLE 2

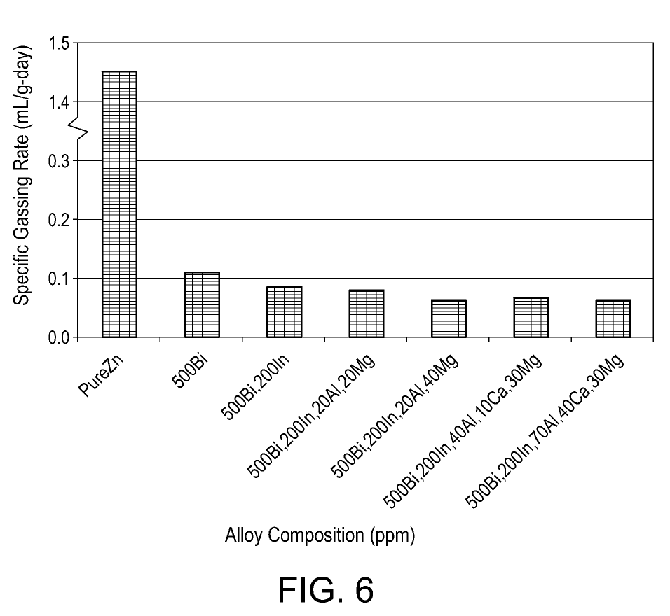

This example describes the gassing performance of fibers. Zinc fiber materials with low gassing rates can be obtained by using zinc alloys. FIG. 6 shows that alloying elements and combinations of these elements at various levels can result in low gassing rate.

### EXAMPLE 3

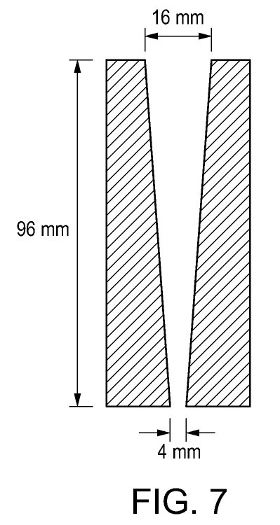

Anode gel fluidity is an important property for effective manufacturing of alkaline batteries. Manufacturers use nozzles with a certain diameter to feed gel into individual cells. Good fluidity is required for smooth feeding. For a given length and thickness of zinc fiber, only up to a maximum amount can be used. Above this amount, gel fluidity can be significantly affected and feeding becomes difficult. Experiments were conducted to show that anode gel mixed with fibers can pass through a tapered funnel, simulating nozzles typically used in the battery manufacturing industry. The inlet of the funnel was 16 mm in diameter, with gradual tapering to an outlet diameter of 4 mm, over a height of 96 mm as shown in FIG. 7. The gel was loaded into the nozzle and extruded from the nozzle using a rubberized piston.

Batches of zinc anode gel were prepared with varying quantities of zinc fibers to explore the effect of fiber addition on gel fluidity. The results of these tests, given in Table 4, showed that gelled electrode material containing 10% of the zinc as fibers was capable of passing through the nozzle just as well as “all powder” slurry. However, gelled electrode material containing 40% of the zinc as fibers was not capable of passing through the nozzle.

TABLE 4
Nozzle test using “Medium” length fibers

| Fiber Content | Passage through nozzle |
|---|---|
| 0% | Successful. 100% passed through easily |
| 10% | Successful. 100% passed through easily |
| 40% | Unsuccessful. 3% passed through, but gel phase |
| | separation observed. |

While a number of exemplary aspects and embodiments have been discussed above, those skilled in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

What is claimed is:

1. An electrochemical cell comprising a cathode, a zinc anode comprising zinc fibers and zinc powder, and electrolyte.

2. The electrochemical cell as claimed in claim 1, wherein the zinc fibers comprise a mixture of zinc fibers of different types.

3. The electrochemical cell of claim 1 wherein the zinc fibers are comprised of one type of zinc fiber.

4. The electrochemical cell of claim 1 wherein the zinc fibers are comprised of two or more types of zinc fibers having different physical shapes and dimensions.

5. The electrochemical cell of claim 1 wherein the zinc fibers are comprised of two or more fibers with different lengths.

6. The electrochemical cell of claim 1 wherein the zinc fibers have a length at least 15 times larger than other dimensions of the zinc fibers and particles of the zinc powder.

7. The electrochemical cell of claim 1 wherein the zinc fibers have a largest dimension that is at least 20 times greater than a second largest dimension of the zinc fibers.

8. The electrochemical cell of claim 1 wherein the zinc fibers have a volumetric aspect ratio of at least 3.

9. The electrochemical cell of claim 1 wherein the zinc fibers make up from 5 to 35 weight percent of the total combined weight of zinc fibers and zinc powder.

10. The electrochemical cell of claim 9 wherein the zinc fibers have lengths in the range of 2 mm and 10 mm, and diameters or thickness in the range of 0.05 mm to 0.3 mm.

11. The electrochemical cell of claim 9 wherein the zinc fibers have lengths in the range of 3 mm to 6 mm, and diameter or thickness in the range of 0.1 mm to 0.2 mm.

12. The electrochemical cell of claim 1 wherein the zinc fibers are comprised of pure zinc.

13. The electrochemical cell of claim 1 wherein the zinc fibers are comprised of a zinc alloy.

14. The electrochemical cell of claim 13 wherein the zinc alloy comprises zinc and one or more elements selected from the group consisting of: indium, bismuth, lead, tin, calcium, aluminum and magnesium.

15. The electrochemical cell of claim 14 wherein a quantity of the indium, bismuth, lead, tin, calcium, aluminum and magnesium in the zinc alloy is between 10 ppm and 5000 ppm.

16. The electrochemical cell of claim 1 wherein the zinc fibers are coated with a coating comprising one or more elements selected from the group consisting of:
indium, bismuth, and lead.

17. The electrochemical cell of claim 1 wherein the zinc fibers are spin cast from molten zinc.

18. The electrochemical cell of claim 1 wherein the zinc fibers, zinc powder and electrolyte are incorporated in an anode gel comprising the electrolyte.

19. The electrochemical cell of claim 18 wherein the electrolyte comprises 25-40% KOH and water.

20. A method for preparing an anode for use in an electrochemical device, the method comprising incorporating zinc fibers in a zinc powder gel electrode.

21. A method according to claim 20 comprising feeding a gelled electrode material comprising the zinc fibers through a nozzle into the electrochemical device.

22. A method as claimed in claim 20 wherein the zinc fibers make up about 10% of a total zinc content of the anode.
